(19) United States
(12) Patent Application Publication
(10) Pub. No.: US 2009/0302003 A1
(43) Pub. Date: Dec. 10, 2009

(54) Aqueous Solution for Chemical Polishing and Deburring and Process for Polishing and Deburring A Part made of Pure Nickel or Nickel-200 Therein

(76) Inventors: Ching-An Huang, Gueishan Township (TW); Chwen-Lin Shih, Gueishan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/133,426

(22) Filed: Jun. 5, 2008

(51) Int. Cl. C09K 13/06; C23F 1/00

(52) U.S. Cl. 216/90; 252/79.4

(57) ABSTRACT

An aqueous solution for polishing and deburring includes pure water; carboxylic acid of 200 gram per liter to 300 gram per liter; sulfuric acid ions of 200 gram per liter to 500 gram per liter; phosphoric acid ions of 100 gram per liter to 300 gram per liter; and nitric acid ions of 50 gram per liter to 200 gram per liter. Also, a process for polishing and deburring a part made of pure nickel or nickel-200 in the solution includes removing oily substance from the part; washing the part by water; pouring the solution into a bath and submerging the part in the solution so that the part is brought into contact with the solution; neutralizing the solution remained on the surface of the part to prevent the part from oxidizing; and drying the part to obtain a finished part.

### BACKGROUND OF THE INVENTION

1. Field of Invention

The invention relates to chemical polishing and deburring and more particularly to an aqueous solution for chemical polishing and deburring and a process for polishing and deburring a part made of pure nickel or nickel-200 in the aqueous solution.

2. Description of Related Art

Parts made of pure nickel or nickel-200 by, for example, punching may have a rough surface and raised edges (i.e., burrs). Typically, a mechanical grinding or scraping operation is performed to polish metal parts.

However, the well known mechanical grinding or scraping technique is disadvantageous due to poor quality and low precision. Hence, mechanical grinding or scraping techniques are not suitable for producing fine parts.

Fine or thin parts (e.g., small washers and fine metal parts) can also be made of pure nickel or nickel-200 by punching. However, the parts may have burrs. Typically, the parts and SiC (silicon carbide) abrasive particles are placed in a rotating cylinder so that the burrs of the parts can be removed by the SiC abrasive particles. However, the cost and time needed to perform the deburring operation is significant. Further, its quality is not acceptable.

Thus, it is desirable to provide a novel chemical polishing and deburring method in order to overcome the inadequacies of the prior art.

### SUMMARY OF THE INVENTION

It is therefore one object of the invention to provide an aqueous solution for chemical polishing and deburring comprising pure water of a predetermined volume; carboxylic acid of 200 gram per liter to 300 gram per liter; sulfuric acid ions of 200 gram per liter to 500 gram per liter; phosphoric acid ions of 100 gram per liter to 300 gram per liter; and nitric acid ions of 50 gram per liter to 200 gram per liter.

It is another object of the invention to provide a process for polishing and deburring a part made of pure nickel or nickel-200 in an aqueous solution prepared as above, comprising the steps of removing oily substance from the part by adding an oily substance removing agent into the solution; washing the part by water to remove the remaining oily substance removing agent adhered on the surface of the part; pouring the aqueous solution into a bath and submerging the part in the aqueous solution so that the part is brought into contact with the aqueous solution; neutralizing the aqueous solution remained on the surface of the part to prevent the part from oxidizing; and drying the part to obtain a finished part.

The above and other objects, features and advantages of the invention will become apparent from the following detailed description taken with the accompanying drawings.

### BRIEF DESCRIPTION OF THE DRAWINGS

FIG. 1 is a flowchart depicting a process for polishing and deburring a part made of pure nickel or nickel-200 according to the invention;

FIG. 2 is a picture showing the part in the left before being subject to the process for polishing and deburring, and the part in the right after being subject to the process for polishing and deburring;

FIG. 3 is a picture showing the part in the left in a longitudinal section view before being subject to the process for polishing and deburring, and the part in the right in a longitudinal section view after being subject to the process for polishing and deburring;

FIG. 4 is a picture showing the part in the left through an OM (optical microscope) before being subject to the process for polishing and deburring, and the part in the right through the OM after being subject to the process for polishing and deburring; and

FIG. 5 is a picture showing the part in the left through an SEM (scanning electron microscope) before being subject to the process for polishing and deburring, and the part in the right through the SEM after being subject to the process for polishing and deburring.

### DETAILED DESCRIPTION OF THE INVENTION

One liter of aqueous solution for chemical polishing and deburring in accordance with the invention can be prepared by adding carboxylic acid of 200 gram per liter to 300 gram per liter, sulfuric acid ions of 200 gram per liter to 500 gram per liter, phosphoric acid ions of 100 gram per liter to 300 gram per liter, and nitric acid ions of 50 gram per liter to 200 gram per liter into pure water.

The carboxylic acid is selected from citric acid, malic acid, oxalic acid, succinic acid, tartaric acid, acetic acid, formic acid and a dissoluble salt of each forgoing acid.

The sulfuric acid ions are selected from sulfuric acid, copper sulfate, nickel sulfate, and a dissoluble salt of each forgoing acid.

The phosphoric acid ions are selected from phosphoric acid, calcium phosphate, sodium phosphate, and a dissoluble salt of each forgoing acid.

The nitric acid ions are selected from nitric acid, ammonium nitrate, sodium nitrate, and a dissoluble salt of each forgoing acid.

The addition of nitric acid ions into the solution can increase voltage at anode to a predetermined potential by electrolysis. Therefore, phosphoric acid ions and carboxylic acid of the acid solution are capable of polishing the surface of a part (e.g., one made of pure nickel or nickel-200 by, for example, punching) and removing burrs from the part submerged in the solution at a temperature in a range of about 25° C. to about 70° C. by uniformly mixing the solution for a period of time between 3 minutes to 10 minutes without applying electric current. It is noted that discharging effect at the sharp edge (e.g., an edge of about 90 degrees) of the part is more significant than that on a flat surface. As a result, a part having a smooth solution and a substantially curved edge is formed. Further, the thickness of the part is substantially no change (i.e., decrease) after etching.

The compositions of carboxylic acid, sulfuric acid ions, phosphoric acid ions, and nitric acid ions in the aqueous solution can be varied as follows:

| | composition | | | |
|---|---|---|---|---|
| | | | phosphoric acid | nitric acid |
| serial # | carboxylic acid | sulfuric acid ions | ions | ions |
| 1 | 120 gram | 80 gram | 240 gram | 80 gram |
| 2 | 110 gram | 120 gram | 240 gram | 90 gram |
| 3 | 250 gram | 180 gram | 210 gram | 150 gram |
| 4 | 300 gram | 200 gram | 120 gram | 100 gram |
| 5 | 100 gram | 160 gram | 240 gram | 80 gram |
| 6 | 250 gram | 320 gram | 140 gram | 100 gram |
| 7 | 250 gram | 80 gram | 240 gram | 50 gram |
| 8 | 200 gram | 350 gram | 120 gram | 120 gram |
| 9 | 220 gram | 90 gram | 180 gram | 20 gram |
| 10 | 260 gram | 330 gram | 120 gram | 120 gram |
| 11 | 100 gram | 60 gram | 240 gram | 30 gram |
| 12 | 210 gram | 340 gram | 150 gram | 120 gram |
| 13 | 60 gram | 250 gram | 100 gram | 50 gram |
| 14 | 120 gram | 250 gram | 125 gram | 100 gram |
| 15 | 320 gram | 40 gram | 40 gram | 100 gram |

Compositions of serial numbers 6, 8, 10 and 12 are preferred. Preferably, the solution is stored in a bath made of a corrosion-proof plastic material such as PP (polypropylene), PVC (polyvinyl chloride), UPE (unsaturated polyester) or PE (polyethylene).

Pure nickel or nickel-200 has the features of high density, hard, wearpoof, conductive, high heat transfer capability, corrosion-proof, and ductile. Hence, parts made of pure nickel or nickel-200 are widely employed in the industry. For example, pure nickel or nickel-200 is widely employed as material in manufacturing lithium cells, synthetic diamonds, electronics industry (e.g., pin mountings on a PCB (printed circuit board)), semiconductor industry, and large washers in the pipe for conveying pressurized gas.

Fine or thin parts (e.g., small washers and fine metal parts) can also be made of pure nickel or nickel-200 by punching.

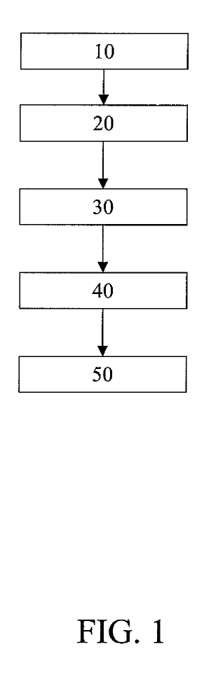

Referring to FIG. 1, a process for polishing and deburring a part (e.g., one made of pure nickel or nickel-200 by, for example, punching) in accordance with the invention is illustrated. The process comprises:

Step 10 of removing oily substance from the part by adding an oily substance removing agent into the solution in which, additionally, a mechanical or ultrasonic removal operation can be performed to increase the amount of removed oily substance.

Step 20 of washing the part by water to remove the remaining oily substance removing agent adhered on the surface of the part.

Step 30 of pouring an aqueous solution prepared as above into a bath, submerging the part in the solution, and uniformly mixing the solution for a period of time between 3 minutes to 10 minutes by mechanical means without applying electric current. As a result, burrs of the part are substantially removed.

Step 40 of neutralizing the solution remained on the part to prevent the part from quickly oxidizing (i.e., preventing the part from rusting).

Step 50 of drying the part to obtain a finished part.

Additionally, a step of washing the part by water before or after step 40 can be performed. Preferably, the washing step is an overflowing step for ensuring a complete removal of the remaining solution from the surface of the part.

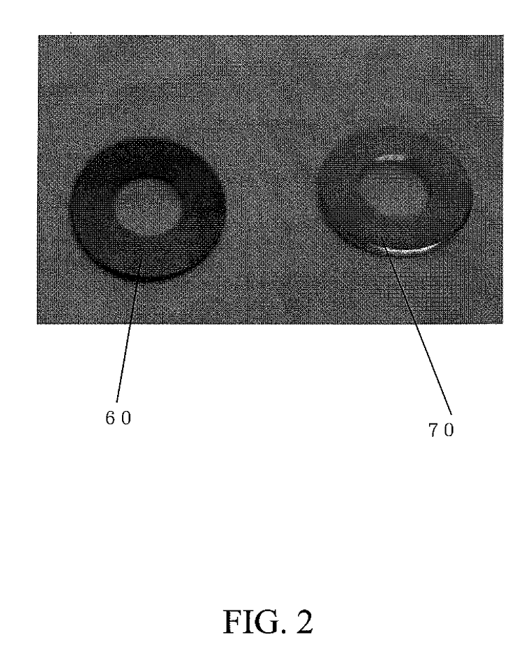

Referring to FIG. 2, the left one 60 shows a part before being subject to the process for polishing and deburring, and the right one 70 shows the part after being subject to the process for polishing and deburring. As a comparison, the left one 60 has a relatively dark, rough surface and the right one 70 has a smooth and shiny surface.

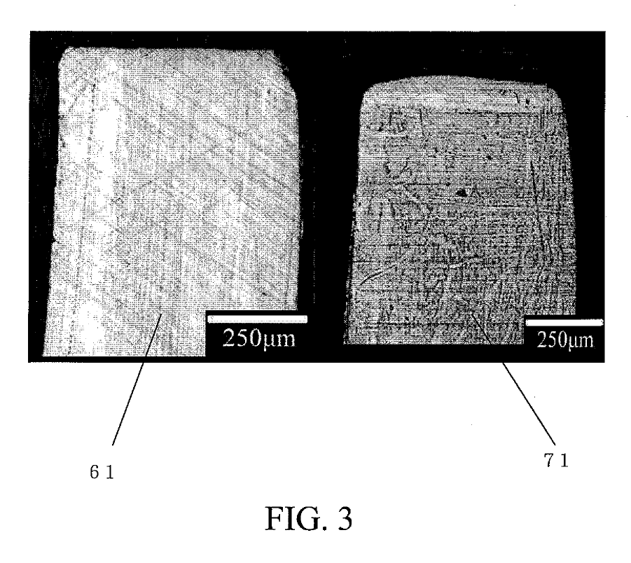

Referring to FIG. 3, the left one 61 shows a part in a longitudinal section view before being subject to the process for polishing and deburring, and the right one 71 shows the part in a longitudinal section view after being subject to the process for polishing and deburring.

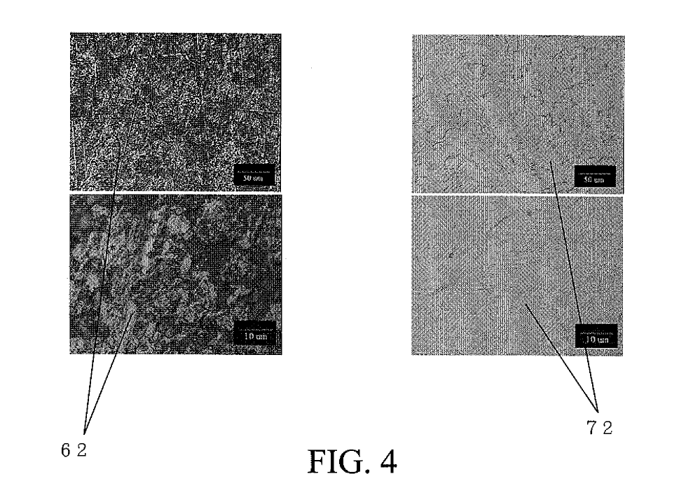

Referring to FIG. 4, the left one 62 shows a part through an OM (optical microscope) before being subject to the process for polishing and deburring, and the right one 72 shows the part through the OM after being subject to the process for polishing and deburring.

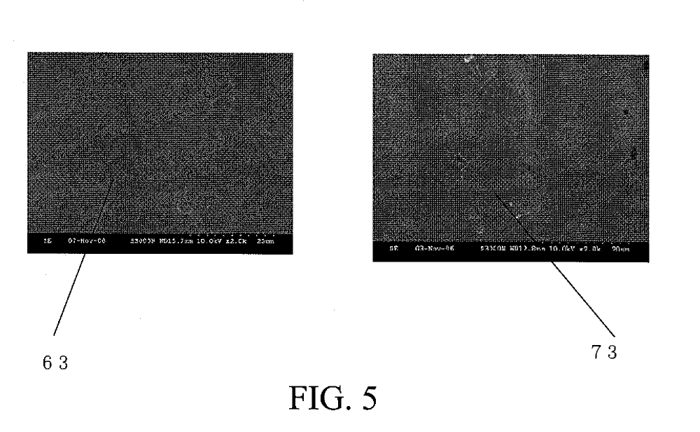

Referring to FIG. 5, the left one 63 shows a part through an SEM (scanning electron microscope) before being subject to the process for polishing and deburring, and the right one 73 shows the part through the SEM after being subject to the process for polishing and deburring.

While the invention herein disclosed has been described by means of specific embodiments, numerous modifications and variations could be made thereto by those skilled in the art without departing from the scope and spirit of the invention set forth in the claims.

What is claimed is:

1. An aqueous solution for chemical polishing and deburring comprising:
pure water of a predetermined volume;
carboxylic acid of 200 gram per liter to 300 gram per liter;
sulfuric acid ions of 200 gram per liter to 500 gram per liter;
phosphoric acid ions of 100 gram per liter to 300 gram per liter; and
nitric acid ions of 50 gram per liter to 200 gram per liter.

2. The aqueous solution of claim 1, wherein the carboxylic acid is selected from citric acid, malic acids oxalic acid, succinic acid, tartaric acid, acetic acid, formic acid or a dissoluble salt of each forgoing acid.

3. The aqueous solution of claim 1, wherein the sulfuric acid ions are selected from sulfuric acid, copper sulfate, and nickel sulfate or a dissoluble salt of each forgoing acid.

4. The aqueous solution of claim 1, wherein the phosphoric acid ions are selected from phosphoric acid, calcium phosphate, and sodium phosphate or a dissoluble salt of each forgoing acid.

5. The aqueous solution of claim 1, wherein the nitric acid ions are selected from nitric acid, ammonium nitrate, and sodium nitrate or a dissoluble salt of each forgoing acid.

6. A process for polishing and deburring a part made of pure nickel or nickel-200 in an aqueous solution according to claim 1, comprising the steps of:
(i) removing oily substance from the part by adding an oily substance removing agent into the solution;
(ii) washing the part by water to remove the remaining oily substance removing agent adhered on the surface of the part;
(iii) pouring the aqueous solution into a bath and submerging the part in the aqueous solution so that the part is brought into contact with the aqueous solution;
(iv) neutralizing the aqueous solution remained on the surface of the part to prevent the part from oxidizing; and
(v) drying the part to obtain a finished part.

7. The process of claim 6, further comprising the step of washing the part by water before or after the step (iv).

8. The process of claim 6, wherein the part is brought into contact with the aqueous solution for a period of time between 3 minutes to 10 minutes.

9. The process of claim 6, wherein the aqueous solution has a temperature in a range of about 25° C. to about 70° C.

10. The process of claim 6, wherein the bath is made of a corrosion-proof plastic material.

11. The process of claim 10, wherein the corrosion-proof plastic material is PP (polypropylene), PVC (polyvinyl chloride), UPE (unsaturated polyester), or PE (polyethylene).
